(19) United States
(12) Patent Application Publication
(10) Pub. No.: US 2013/0275259 A1
(43) Pub. Date: Oct. 17, 2013

(54) Authoring and Retrieving Customized Product Content for Online Product Stores

(71) Applicant: Nirmal Chidambaram, Round Rock, TX (US)

(72) Inventor: Nirmal Chidambaram, Round Rock, TX (US)

(73) Assignee: DELL PRODUCTS, LP, Round Rock, TX (US)

(21) Appl. No.: 13/445,043

(22) Filed: Apr. 12, 2012

(51) Int. Cl. G06Q 30/00

(52) U.S. Cl. 705/26.7

(57) ABSTRACT

A method stores in a persistence layer a plurality of rules specifying an association between personalized information about potential visitors to an online product store and products of the online product store, obtains personalized information about an actual visitor to the online product store, and executes the rules by a computer, thereby selecting products of the online store based upon the personalized information about the actual visitor. The method further displays information about the selected products of the online store to the actual visitor.

### FIELD OF THE DISCLOSURE

This disclosure generally relates to information handling systems, and more particularly relates to generating customized product content for online product stores.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems. The information or data processed and stored by information handling system may include customized product content for online product stores.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating a computer network according to an embodiment of the present disclosure;

FIG. 2 is a block diagram illustrating an online product module according to an embodiment of the present disclosure;

FIG. 3 is a flow diagram illustrating a method according to an embodiment of the present disclosure;

FIGS. 4A and 4B are flow diagrams illustrating another method according to an embodiment of the present disclosure;

FIG. 5 is a block diagram illustrating a data structure according to an embodiment of the present disclosure;

FIG. 6 is a flow diagram illustrating another method according to an embodiment of the present disclosure; and

FIG. 7 is a block diagram of an information handling system according to an embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other teachings may be utilized in this application, as well as in other applications and with several different types of architectures such as distributed computing architectures, client/server architectures, or middleware server architectures and associated components.

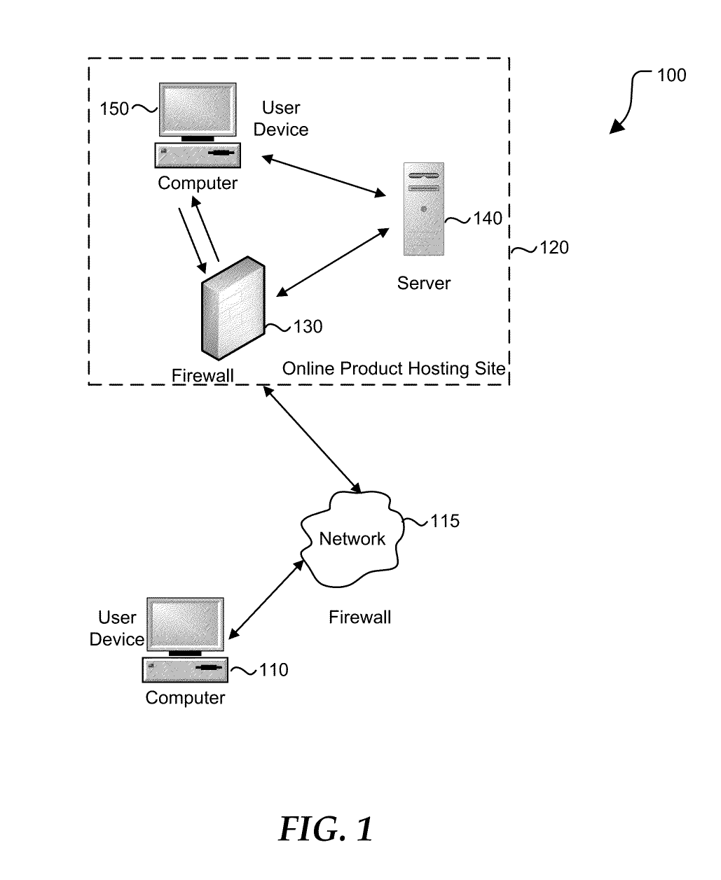

FIG. 1 shows a networked computer environment 100 that includes an information handling system 110. An information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network server or storage device, a switch router, wireless router, or other network communication device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communications between the various hardware components.

Networked computer environment 100 also includes online product hosting site 120. Online product hosting site 120 includes server 140 and user device 150, positioned behind firewall 130. Information handling or user device 110 may also include a network card or other network interface enabling it to communicate over communications network 115. User device 110 may be configured with conventional web browser software. The web browser, such as Microsoft's Internet Explorer, may enable a user to interact with websites via the network 115.

Online product hosting site 120 may generate content for a web site that displays products for purchase to site visitors. Authors of content at client device 150 may be involved in the generation of content for the web site. They may author product content, including product content that may be personalized or demographic for customers. They may, for example, create or modify content describing particular products. They may also create content that affects the display of products. As an example, they may create content used in graphical displays on the web site. The authors may also create or modify content that relates particular user characteristics to particular products. In some embodiments, this relational content may be in the form of rules. The content authors at client device 150 may transmit the content to server 140. They may also communicate over network 115 with other network devices.

Server 140 may receive messages, such as hyper text transfer protocol (http) requests, from users visiting the web site and may respond to the messages. Server 140 may store information used to operate the web site, such as product information, display information, and the relational information. Server 140 may receive new and updated information from web site technicians operating at user device 150. Server 140 may include conventional computer hardware and commercially available Enterprise Resource Planning (ERP) and other business process software such as QuickBooks, SAP's MySAP ERP, Oracle's OneWorld JD Edwards ERP, and Infor's WMS application.

A user at client device 110 may be interested in purchasing a product displayed on a web site hosted by online product hosting site 120. The user may connect to the web site, examine the products displayed, and select one. The display may be personalized to the user based upon information obtained from the user, such as previous purchases, browsing history, product requests from the user, and other information supplied by the user. The display may also be customized based on other parameters, such as the time of year.

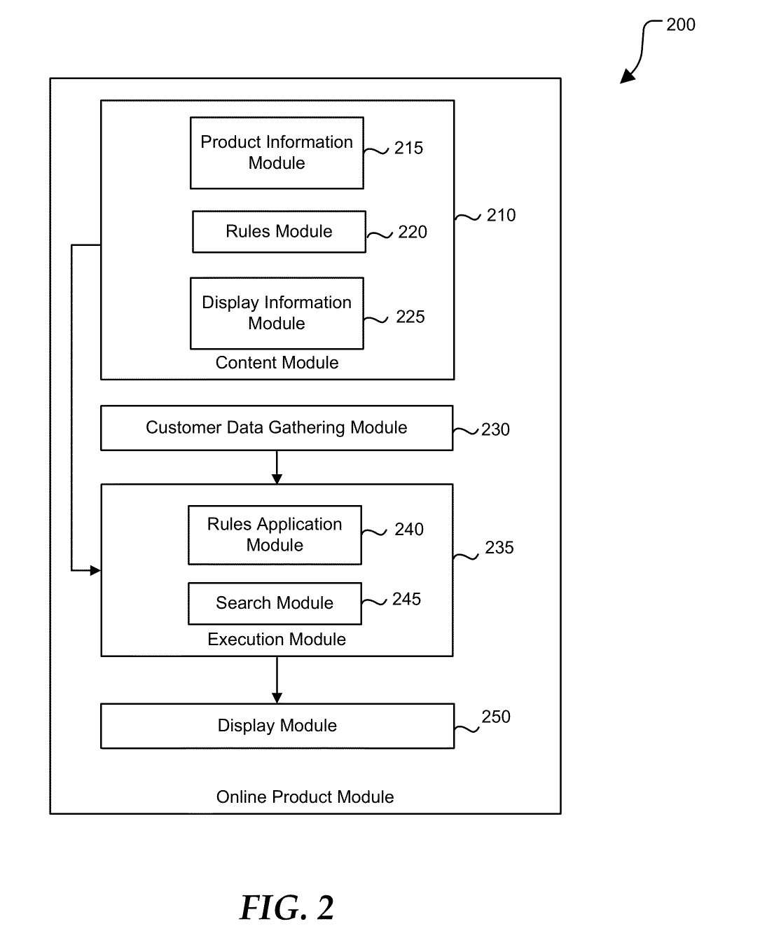

FIG. 2 shows an online product module 200 that may generate customized displays for online visitors. Online product module 200 includes content module 210, customer data gathering module 230, execution module 235, and display module 250. Content module 210 contains content used by online product module 200. It includes production information module 215, rules module 220, and display information module 225.

Product information module 215 may contain information about what products are available and their descriptions, including prices, features, components, performance, options, and related products. Rules module 220 may contain rules that relate information about a customer to available products. As an example, a rule may indicate that high-end gaming computers should be displayed to a customer who frequently purchases video games and has not purchased one recently. A rule may also relate products to other parameters, such as the day of the week or the season of the year. A general retail outlet may, for example, feature costumes or candy on displays near Halloween. The rules may also relate to display. A rule may, for example, provide that a President's Day display to a potential customer in the United States should show a graphic of famous presidents. In some embodiments, a rule may specify one or more folders to search, based upon customer information or other data. A folder may contain the locations of information about products or other features of an online product display.

In some embodiments, content may be grouped into collections. A collection may logically group content required for a specific purpose. For example, “left-navigation captions” may be a collection that groups all tokens and their values used for a left navigation menu presented in a product catalog. Collections may be composed of folders. In further embodiments, rules may be set in a collection level and may define a folder or folders from which values should be taken for a given set of attributes. An attribute may be information about a customer, such as the product of interest to the customer or the nationality of the customer. It may also be other information related to marketing, such as an upcoming holiday. There may be multiple rule templates for a collection. In some embodiments, a default rule template is mandatory for each collection. The default template may be mandatory and may be used unless a requester asks for a specific rule. Rules may have a tree structure, providing branches and hierarchy. Following is exemplary pseudo-code of a rule for a collection named general-population-movies:
1. For UK, English, family viewers—first look for movies in ukenfamily;
2. After processing ukenfamily, then process ukenglish, and include tokens and values in that folder as well. Take care not to override the token/value pairs from 1. Thus, if a token/value pair (foo, bar) was returned in step 1, and a token/value pair (foo, bar-2) was returned in step 2, then the second token/value pair with the same token and different value would be discarded;
3. Repeat for English—general.

The following table shows a sample rule in XML format, which may be used in an online catalog for movie products. Rules may be in formats other than XML. This sample rule may be a small portion of the size of an actual rule in some embodiments.

XML Rule Formats

| | |
|---|---|
| 1 | <?xml version=“1.0”?> |
| 2 | <locales> |

| | |
|---|---|
| 3 | <locale src=“/ar/_values” fallback=“/US-En/_values” l=“ar”> |

| | |
|---|---|
| 4 | <locale src=“/ar/family/_values” g=“family”/> |
| 5 | <locale src=“/ar/adult/_values” g=“adult”/> |
| 6 | <locale src=“/ar/children/_values” g=“children”/> |
| 7 | <locale src=“/ar/music/_values” fallback=“/ar/children/_values” g=“music”/> |
| 8 | <locale src=“/ar/romantic/_values” fallback=“/ar/music/_values” g=“romantic”/> |
| 9 | <locale src=“/ar/sci-fi/_values” fallback=“/ar/music/_values” g=“sci-fi”/> |
| 10 | <locale src=“/ar/thrillers/_values” fallback=“/ar/music/_values” g=“thrillers”/> |
| 11 | <locale src=“/ar/classic/_values” fallback=“/ar/music/_values” g=“classic”/> |
| 12 | <locale src=“/ar/comedies/_values” fallback=“/ar/music/_values” g=“comedies”/> |
| 13 | <locale src=“/ar/action/_values” fallback=“/ar/family/_values” g=“action”/> |
| 14 | <locale src=“/ar/TV/_values” fallback=“/ar/family/_values” g=“TV”/> |
| 15 | <locale src=“/ar/docs/_values” fallback=“/ar/adult/_values” g=“docs”/> |

| | |
|---|---|
| 16 | </locale> |
| 17 | <locale src=“/da/_values” fallback=“/US-En/_values” l=“da”> |

| | |
|---|---|
| 18 | <locale src=“/da/family/_values” g=“family”> |

| | |
|---|---|
| 19 | <locale src=“/da/family/foreign/_values” r=“foreign”> |

| | |
|---|---|
| 20 | <locale src=“/da/family/foreign/dk/_values” c=“dk”/> |

| | |
|---|---|
| 21 | </locale> |

| | |
|---|---|
| 22 | </locale> |
| 23 | <locale src=“/da/adult/_values” g=“adult”> |

| | |
|---|---|
| 24 | <locale src=“/da/adult/foreign/_values” r=“foreign”> |

| | |
|---|---|
| 25 | <locale src=“/da/adult/foreign/dk/_values” c=“dk”/> |

| | |
|---|---|
| 26 | </locale> |

| | |
|---|---|
| 27 | </locale> |
| 28 | <locale src=“/da/children/_values” g=“children”> |

| | |
|---|---|
| 29 | <locale src=“/da/children/foreign/_values” r=“foreign”> |

| | |
|---|---|
| 30 | <locale src=“/da/children/foreign/dk/_values” c=“dk”/> |

| | |
|---|---|
| 31 | </locale> |

| | |
|---|---|
| 32 | </locale> |
| 33 | <locale src=“/da/music/_values” fallback=“/da/children/foreign/dk/_values” g=“music”/> |

| | |
|---|---|
| 34 | <locale src=“/da/romantic/_values” fallback=“/da/music/_values” g=“romantic”/> |
| 35 | <locale src=“/da/sci-fi/_values” fallback=“/da/music/_values” g=“sci-fi”/> |
| 36 | <locale src=“/da/thrillers/_values” fallback=“/da/music/_values” g=“thrillers”/> |
| 37 | <locale src=“/da/classic/_values” fallback=“/da/music/_values” g=“classic”/> |
| 38 | <locale src=“/da/comedies/_values” fallback=“/da/music/_values” g=“comedies”/> |
| 39 | <locale src=“/da/action/_values” fallback=“/da/family/_values” g=“action”/> |
| 40 | <locale src=“/da/TV/_values” fallback=“/da/family/_values” g=“TV”/> |
| 41 | <locale src=“/da/docs/_values” fallback=“/da/adult/_values” g=“docs”/> |

| | |
|---|---|
| 42 | </locale> |
| 43 | </locales> |

Elements of the sample rule begin with the symbol “<” and the name of the element, such as “locale.” Following the name of an element is a list of key/value pairs, such as g (genre)=family, or g=music. The sample rule is a tree structure. Children are denoted by indentation. Thus, for example, the element of the rule on row 26 is a child node of the element on row 25. Elements of the rule end with the characters “/>” when the element is a leaf node. In this case, the entire element is enclosed with “<” and “/>” delimiters. See, for example, the elements on row 11. In other cases, however, an element terminator is separate from the line containing the beginning of the rule, and terminates with “</” rule-name “>” For example, the rule named “locale” beginning on row 3 ends on row 24 with “</locale>”. This rule contains several children nodes, all leaf-nodes, such as those beginning on rows 4-7.

This sample rule contains information on how to search for product information. If the current attributes satisfy the conditions of an element of the rule, then product information is obtained from the indicated source “src.” For example, the rule at row 5 specifies that the genre is adult. If a user is looking for an adult movie and the search hits this portion of the rule, then information about movies may be obtained from a source, such as a folder, named=“/ar/adult/_values.” In addition, elements of the rule provide fallback positions—sources to be examined after the source in the particular element. For example, the rule starting at row 8 says to check the “/ar/music/_values” source after checking the “/ar/romantic/_values” source.

Display module 225 may contain data about the display of products by online product module 200, such as, for example, the graphical icons that may be shown on the left side of a page or the user interface for a shopping cart. Customer data gathering module 230 may gather information about a customer. The information may be based upon purchase history, on the selections that the customer expresses interest in, on the customer's responses to questions on the web site, and on information obtained from the customer's contract with the web site, such as country of login.

Execution module 235 may apply the rules of rules module 220 to the customer information from customer data gathering module 230 and the content from content module 210 to customize the display of information to a visitor to an online catalog. Execution module 235 contains rules application module 240 and search module 245. Execution module 235 may apply the rules of rules module 220. The application of rules may generate data about the display of information, such as a green banner on Saint Patrick's Day. The data may also include particular product information.

The application of a rule may, however, result in a query. A rule may indicate a particular portion of a product database to search for products that match information about the customer. A rule may indicate, for example, to search the database of home computers for high-end home computers, based upon the order history of a potential customer. Application of the rule may produce a query, to be run against the home computer's database. Search module 245 may perform the query. In the above example, search module 245 may examine the price of each item in the home computer's database and return items with prices above a fixed price. Other embodiments of the invention may use different mechanisms to relate customer information and other parameters to produce information or display information. In other embodiments, for example, a table or other data structure may relate parameters to display information.

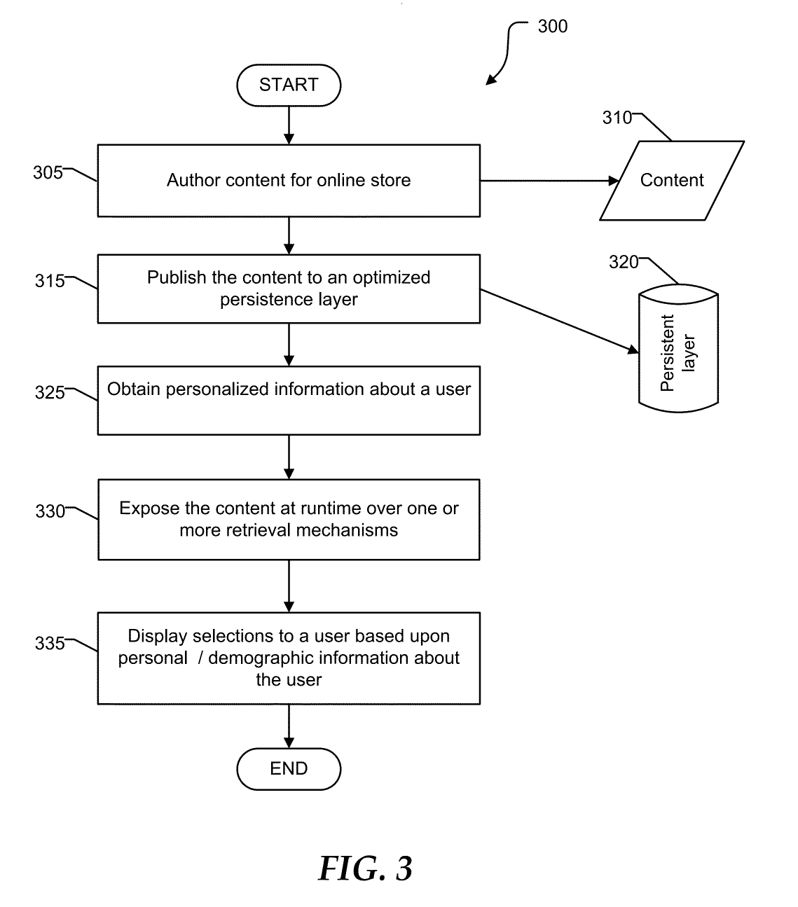

FIG. 3 shows a method for generating displays in online stores. The method may be performed by an online product module such as online product module 200 of FIG. 2. The method begins with authoring content for an online store at block 305, thereby producing content 310. There may be a group of content authors/marketers who manage text and other data primarily for the purpose of its use in the online store. In some embodiments, content authors may enter data about products, such as types of products and features. Marketers, in contrast, may generate content to implement sales campaigns. They may, for example, insert rules to stress the display of back-to-school computers when the beginning of fall is approaching. The content authored by the two groups may overlap in part. In other embodiments, one group of people may author content for both product information and marketing strategies. In some embodiments, the authoring process may include inserting key/value pairs into folders of collections. Collections may group related content. The grouping may enable the authored data to stay close to where it is consumed.

Content 310 may include product information, display information, and relational information tying products with customer information. The product information may include technical specification of products and may include a variety of options available in purchasing products. Display information may include information such as graphics to be displayed on the website of the online store, the color of display, and the formatting of displays. For example, one type of content may include a file of “left-navigation-captions” which groups all tokens and values used for a left navigation menu displayed in the online store. Relational information may be in the form of rules. A rule may, for example, state that if the customer accesses the online store from England, is an English-speaker, and requests information about home computers, then the first set of displays to the customer should be found in a ukenhome folder.

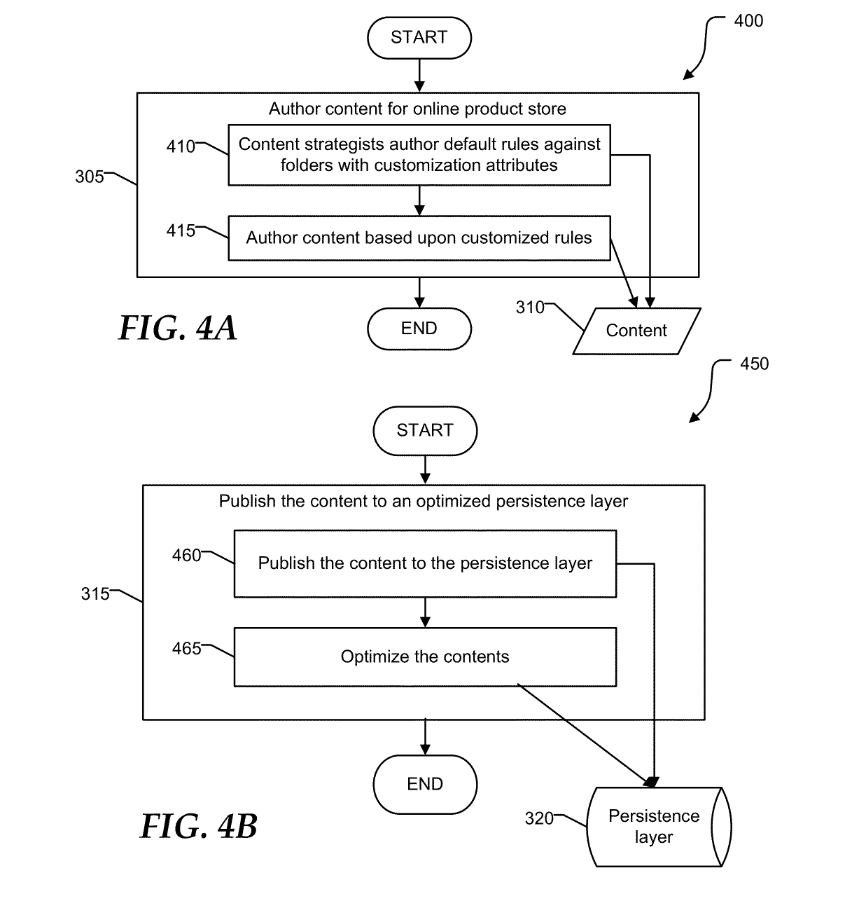

Block 305 is shown in more detail in FIG. 4A, where it is further subdivided. At block 410, content strategists author default rules against folders with customization attributes. A default rule may be mandatory and may be used if a requester does not ask for a specific rule. As an example, websites for mobile, tablet, and desk top computers may utilize different rule templates, with different default rules. A requester may be a system to provide product-related information in a form to an end-user or customer, such as a customer web application or a catalog printing system.

The flow proceeds to block 415, where an author writes content based upon customized rules. This content may consist of rules which relate personalized or demographic characteristics about a visitor to the online store to products displayed in the online store. A rule may, for example, base the selection of products to be displayed to a visitor on the visitor's age or native language.

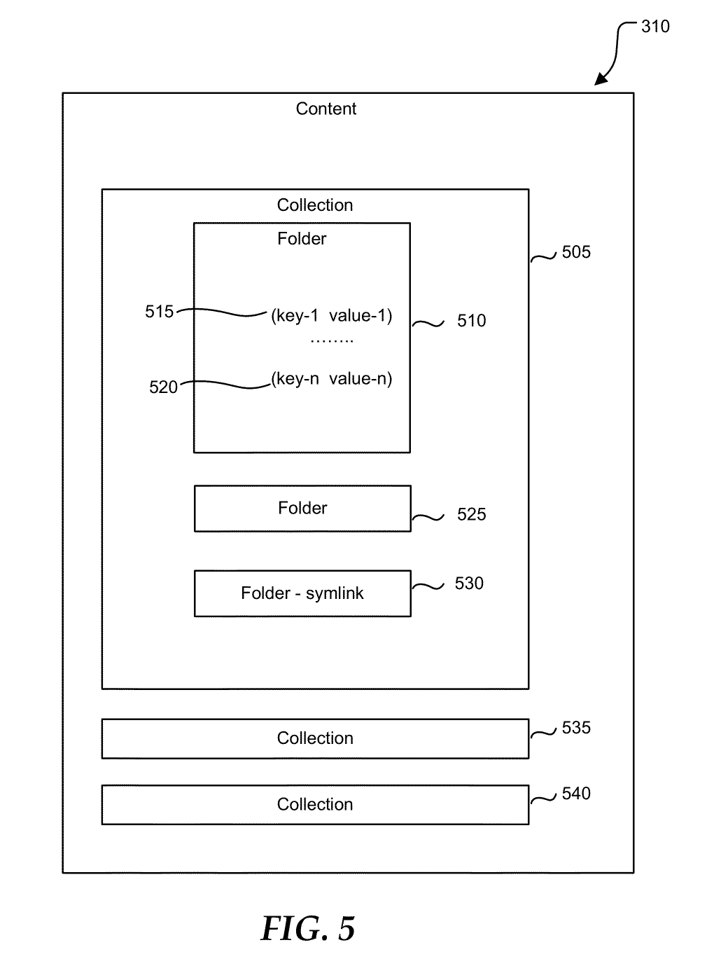

FIG. 5 shows that content may be divided into collections 505, 535, and 540. A collection may be a grouping of related content. A collection may be made up of folders, such as folders 510, 525, and 530. Folder 530 illustrates a symlink, content to be dynamically pulled from an external source through a predefined remote call. In some embodiments, a data structure representation of a collection may consist of:

COLLECTION: NAME
[
BITMASK: APPLICABLE_RULES
FOLDER[ ] : FOLDERS
DATETIME: LASTUPDATED
RULES_BITMASKS[ ] : RULE RECORDS
]

The NAME parameter of a collection specifies the name of the collection. The FOLDER parameter is the list of folders making up the collection. The DATETIME parameter provides a date of the collection, such as the date of last updating. The BITMASK parameter may list applicable rules to be run against the content of the collection. The rules may be in bitmask form. The RULES_BITMASKS may contain the actual rules.

The folders may contain key/value pairs. Thus folder 510 is shown containing two key/value pairs, pair 515 and pair 520. A key/value pair consists of a key or token and a value. Examples are (language, English) or (genre, science fiction). Values may be strings or internal serialized representations of data.

In some embodiments, the key/value pairs may be represented as bitmasks. Tokens may be hashed to produce bit masks. In further embodiments, the hash algorithm may be a dictionary-based hash algorithm. Tokens are hashed and the bit masks stored. If a hash of a token produces a collision with a hash value in the dictionary, then the token is assigned a non-colliding hash value and the new hash value is stored in the dictionary.

In some embodiments, a data structure representation of a folder may consist of:

```
FOLDER: NAME
      [
      BITMASK: KEYS
      DATETIME: LASTUPDATED
      ]
```

The NAME parameter of a folder specifies the name of the folder. The FOLDER parameter is the list of folders making up the collection. The DATETIME parameter provides a date of the folder, such as the date of last updating. The BITMASK parameter may list the bitmask values of the keys in the folder after the hashing algorithm has been applied.

Returning to FIG. 3, the flow proceeds to block 315 where the content is published to an optimized persistence layer. Data is published in a persistence layer if it may outlive the process that created it. As an example, data may be published in a persistence layer if it is stored in non-volatile memory. In contrast, a data-base query of a user which is not available to the user after the end of a data-base session may not be published to a persistence layer. In particular, storage of rules created at block 305 in a persistence layer may enable their reuse.

Block 315 is further explained in FIG. 4B. At block 460, content is published to the persistence layer. At block 465, the content is optimized. The content may be optimized, for example, by generating bit masks for key by a customized hashing process. In some embodiments, keys and related contents may be stored in the persistence layer by leveraging an inverted index data structure.

Returning to FIG. 3, the method also includes obtaining personalized information about a potential customer at block 325. The information may include current preferences for products, country, language, region, previous purchase history, and any other information that may prove useful in suggesting products to the customer. The information may be based upon previous interactions with the customer, indications of product interest, or responses to survey questions.

The method also includes exposing the content 310 at runtime over one or more retrieval mechanisms at block 330. As an example, the content may include rules based upon personalized information about a potential customer. When personalized content is obtained from a customer at block 325, the personalized content may be compared with the rules. If a rule applies, then it may be executed, to determine information about products that may be especially tailored to the customer. A variety of retrieval mechanisms may be utilized to obtain data. In one or more embodiments, the mechanisms may include:

HTTP based API using REST syntax;

Query engine which accepts SQL-like query language with extensions;

class libraries (C# programming language); and

WCF (distributed communication platform from Microsoft).

In some embodiments, product information may be obtained through the use of the following type of SQL statement, described in Extended Backus-Naur Form:

<query> ::= select <projection> | * FROM <collection-specifier> BY
<context>
[APPLY <rule>]
<projection> := <literal>
<collection-specifier> := <literal>
<rule> := <literal>
<context> := <literal>
<literal> := ““ <text> ”” | ““ <text> ””

Execution of the above SQL query statement might result in a search of the folders in the collection named “collection-specifier” under a context determined by the value of attributes of a customer. The search would apply the rule named “rule,” comparing the values of attributes to the values provided in the rule. In the case a rule is tree structured, the above SQL query statement might search the specified collection by traversing the tree structure of the rule. At each node, the application of the rule might generate a particular search of the collection or some subparts of the collection

An example of this type of SQL query statement is:
SELECT INSPIRON-30 FROM PRODUCTMERCHANDIZING BY “P:LAPTOPBUYER” APPLY RULE “DEFAULT”
   Execution of this statement may return product content about the inspiron-30 from the product merchandizing collection. The execution may apply default rules, such as looking for products for use in the home and products for English-speaking customers.

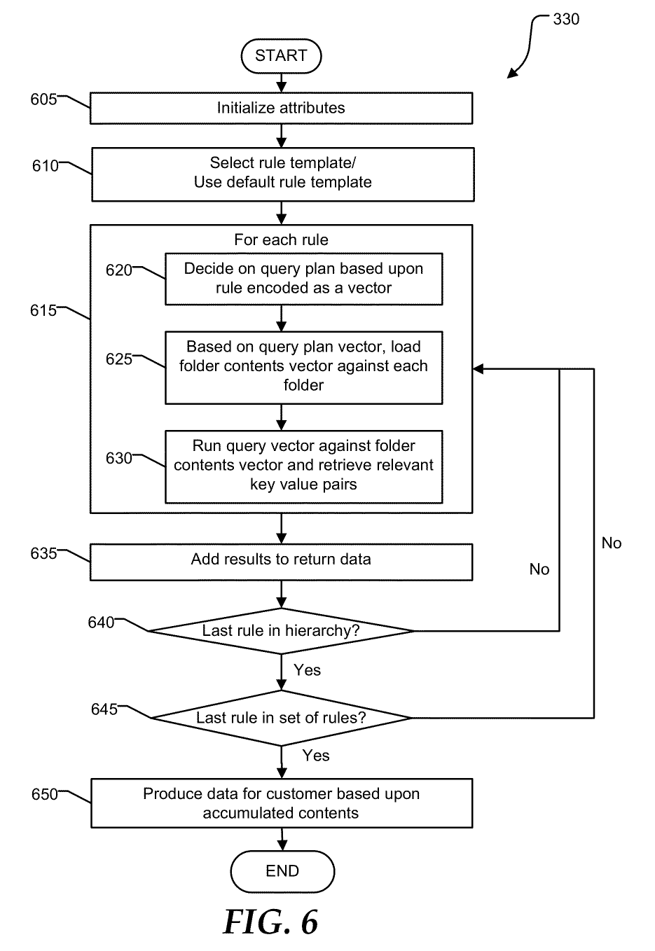

The process of exposing the content at runtime is shown in more detail in FIG. 6. Returning to FIG. 3, the flow proceeds to block 225, where content is exposed at runtime over one or more retrieval mechanisms. Block 225 is described in more detail in FIG. 6. FIG. 6 begins with block 605, where attributes are initialized. The attributes may be attributes upon which rules are based, such as customer attributes or marketing attributes such as an upcoming holiday. As an example, a rule may specify folders based upon the language spoken by a web site visitor. In this case, the visitor language would be an attribute to be initialized. Attributes may include user attributes such as country, language, type of product, customer group, or past purchasing history. In some embodiments, some attributes may be obtained from cookies from the visitor's previous visits to the web site. The attributes of a user may determine a current context, based upon user attributes such as country, language, segment, internal business segment, internal purchase group, and past purchasing history.

The flow proceeds to block 610, where a rule template is selected. If a requester does not specify a rule template, then a default rule template may be used. There may be multiple rule templates for a collection. In some embodiments, a default rule template is mandatory for each collection. The default template may be mandatory and may be used unless a requester asks for a specific rule. As an example of default rules, if attributes of a visitor are known, such as the visitor's language and country, then a rule may attempt to tailor product display based upon those attributes. If no attributes are known, a default product display may be used.

The flow proceeds to block 615, which contains sub blocks 620, 625, and 630. Block 615 is run for each rule in a collection. The rules may be grouped into hierarchies. In some embodiments, rules at one layer of a hierarchy may be executed before rules at another layer of the hierarchy. In further embodiments, the hierarchies may be based upon specificity. Rules based upon matching more customer attributes may be executed before rules matching fewer customer attributes. For example, a rule to return data about home computers for English-speaking customers from England may be executed before a rule to return data about home computers for customers from England. In sub block 620, an online product module such as online product module 200 may decide on a query plan based upon the rule encoded as a vector. In some embodiments, a rule may incorporate a tree structure, as the sample rule in XML format shown above. In those embodiments, the query plan may follow the tree structure of the rule. As an example, the query plan may traverse the rule to the leaf nodes and attempt to apply those by comparing attributes to the conditions of the rule. After applying a set of nodes, the query plan may then travel to the parent nodes of those nodes. In some embodiments, a tree-structured rule may be encoded as a vector by determining an order of traversal of the nodes of the rule. The ith element of the vector may be the ith element of the rule under the particular order of traversal.

The flow proceeds to block 625, where an online product module may load folder contents vector against each folder, based on the query plan vector. The flow proceeds to block 630, where the query vector is run against the folder contents vector to retrieve relevant key/value pairs. The key/value pairs may provide information about the location of product data for display to the visitor to the online store. In some embodiments, the location information may be provided by leveraging an inverted index data structure. In some embodiments, the method would prevent overwriting key/value pairs obtained from a more specific level of a hierarchy with key/value pairs obtained from a more general level of a hierarchy. As an example, the method may include comparing a key/value pair obtained from the more general level of the hierarchy with a key/value pair obtained from the more specific level of a hierarchy. If the keys match, but the values are different, indicating that a value might be overwritten, then the key/value pair from the more general level of the hierarchy may be discarded.

The flow proceeds to block 635, where the results of block 630 may be added to return data. At block 640, a check is run whether the current rule is the last rule in a rule hierarchy. If not, the flow returns to block 615 to apply the next rule in the hierarchy. If, at block 640, the rule was the last rule in the hierarchy, the flow proceeds to block 645, where a check is run whether the rule was the last in the set of rules. If not, the flow proceeds to block 615 with the first rule in the next rule hierarchy. If, at block 645, the rule was the last rule in the set of rules, then the flow proceeds to block 650, where data is produced for a customer based upon based upon the accumulated contents.

Returning to FIG. 3, the method includes displaying selections to the user based upon the personal/demographic information about the user. In this application, the terms “personal” and “personalized” may also include demographic information and localization information. Demographic information may include information about a user's segment of the general population, such as age. Localization information is information about the locale of a user, such as country, language, or region.

For example, an English speaking customer from Great Britain who desires a home computer may be shown particular home computers that operate in the English language. As another example, a potential customer interested in gaming may be shown a certain class of computers especially suited for gaming. As another example, on Saint Patrick's Day, the display may include a green banner. In some embodiments, the display to a customer may include product data and string data. The product data may include such parameters as title, subtitle, and description. The string data may include marketing text emphasizing the value of a product, such as its speed or attractive components.

Other embodiments of the invention may utilize different data structures and algorithms to personalize or customize the display to a visitor to an online catalog. In some embodiments, the rules may be flat, rather than tree-structured. In some embodiments, folders or other data structures may be generated, based upon the rules, and may contain information about the location of product information. For example, a movie company that wanted to differentiate based upon genre, nationality, and language may create a folder that contained information about family movies in English that were suited for English viewers. In other embodiments, runtime execution of the rules may lead to search of a business's catalog. For example, a business may classify each movie by language and nationality. To suggest movies to an English-speaking customer from England who desires family movies, the family movie subsection of a catalog may be searched for English-language movies suitable for viewers from England.

In some embodiments of FIGS. 3-6, rules and other data may be encoded as bitmasks. In other embodiments, other data representations may be used. In some of the embodiments of FIGS. 3-6, data is divided into collections and subdivided into folders. Some rules applicable to a collection may be contained in the collection. In other embodiments, different forms of data organization may be used. In particular, rules may be stored separately from data.

Some embodiments of the invention may provide a flexible method of customizing a display to a user. The method may provide for authoring and generating product catalogs on website, specific to a user based upon the user's current preferences, including country, language, region, targeted sales group, etc. Product catalog content may be authored at a generic level by content designers and marketers may customize atomic level content dynamically based on the preferences and sales history. The mechanism may also enable a marketing team to repurpose existing content for multiple groups in a dynamic fashion. In some further embodiments, an online catalog may change its display without hard-coding the changes. The changes may be made dynamically, rather than requiring a temporary shut-down. In some embodiments, the flexibility may offer the following benefits:
1. The ability to separate the authoring of text data from the authoring of the rules. On one day, the site may target laptop buyers to a “backtoschool” folder in a collection. On the next day, the site may target laptop buyers to a “windows7specials” folder. The change may require a minimum change in the rules. The programmers creating the rules can be different from the content producers. In some cases, the rules can be changed without changing the data about products.
2. Fast retrieval times because of the optimized data structures, such as bitmask structures, the structure of the rules, the nature of the folders, and the runtime algorithms for applying the rules. In further embodiments, the average retrieval time may be less than 50 ms.
3. Ability to add multiple layers of customized content based on business demands. The hierarchical nature of the rules enables the addition of a layer in the rules. As an example, a layer could be added to a rule for the United States to distinguish rural customers from urban customers.
4. Defined processes and constructs to integrate external text data into the mechanism. The integration of external text data could be accomplished, for example, through symlinks and predefined remote calls which are embodied in a contents folder.

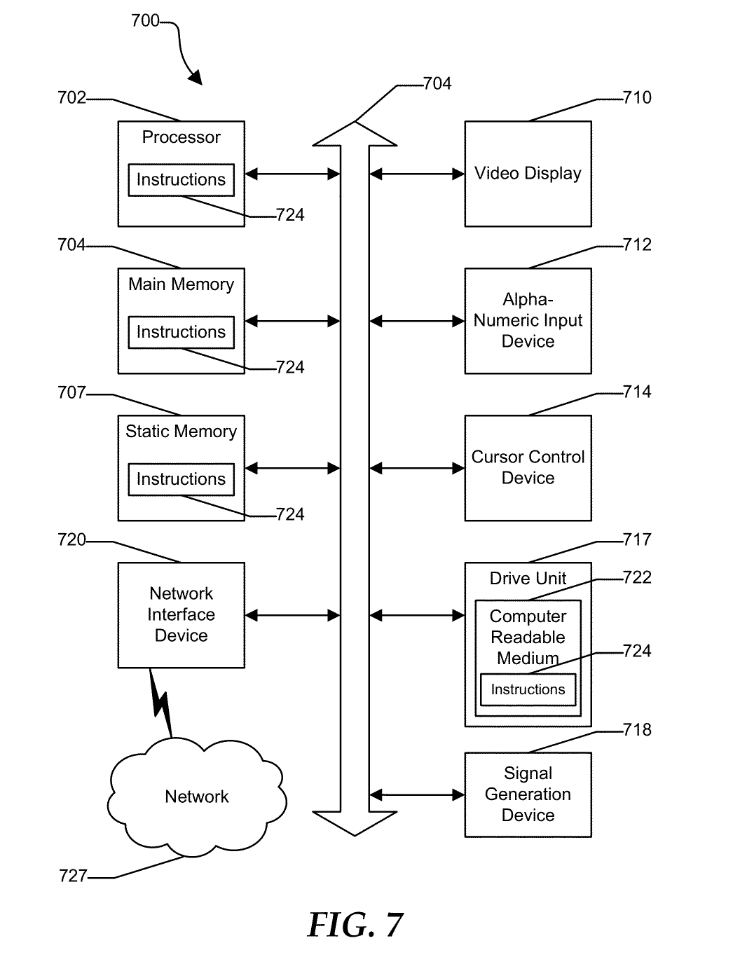

FIG. 7 shows an information handling system 700 capable of administering each of the specific embodiments of the present disclosure. The information handling system 700 can represent the user devices 110 and 150 or the server 140 of FIG. 1 or another data processing devices associated with an online product hosting site or a visitor of an online product site as in networked environment 100.

The information handling system 700 may include a processor 702 such as a central processing unit (CPU), a graphics processing unit (GPU), or both. Moreover, the information handling system 700 can include a main memory 704 and a static memory 706 that can communicate with each other via a bus 708. As shown, the information handling system 700 may further include a video display unit 710, such as a liquid crystal display (LCD), an organic light emitting diode (OLED), a flat panel display, a solid state display, or a cathode ray tube (CRT). Additionally, the information handling system 700 may include an input device 712, such as a keyboard, and a cursor control device 714, such as a mouse. The information handling system 700 can also include a disk drive unit 716, a signal generation device 718, such as a speaker or remote control, and a network interface device 720. The information handling system 700 can represent a server device whose resources can be shared by multiple client devices, or it can represent an individual client device, such as a desktop personal computer.

The information handling system 700 can include a set of instructions that can be executed to cause the computer system to perform any one or more of the methods or computer based functions disclosed herein. The computer system 700 may operate as a standalone device or may be connected such as using a network, to other computer systems or peripheral devices.

In a networked deployment, the information handling system 700 may operate in the capacity of a server or as a client user computer in a server-client user network environment, or as a peer computer system in a peer-to-peer (or distributed) network environment. The information handling system 700 can also be implemented as or incorporated into various devices, such as a personal computer (PC), a tablet PC, a set-top box (STB), a PDA, a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 700 can be implemented using electronic devices that provide voice, video or data communication. Further, while a single information handling system 700 is illustrated, the term “system” shall also be taken to include any collection of systems or sub-systems that individually or jointly execute a set, or multiple sets, of instructions to perform one or more computer functions.

The disk drive unit 716 may include a computer-readable medium 722 in which one or more sets of instructions 724 such as software can be embedded. Further, the instructions 724 may embody one or more of the methods or logic as described herein. In a particular embodiment, the instructions 724 may reside completely, or at least partially, within the main memory 704, the static memory 706, and/or within the processor 702 during execution by the information handling system 700. The main memory 704 and the processor 702 also may include computer-readable media. The network interface device 720 can provide connectivity to a network 726, e.g., a wide area network (WAN), a local area network (LAN), or other network.

In an alternative embodiment, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 724 or receives and executes instructions 724 responsive to a propagated signal; so that a device connected to a network 726 can communicate voice, video or data over the network 726. Further, the instructions 724 may be transmitted or received over the network 726 via the network interface device 720.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure.

Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A method comprising:
storing in a persistence layer a plurality of rules specifying an association between personalized information about potential visitors to an online product store and products of the online product store;
obtaining personalized information about an actual visitor to the online product store;
executing the rules by a computer, thereby selecting products of the online store based upon the personalized information about the actual visitor; and
displaying information about the selected products of the online store to the actual visitor.

2. The method of claim 1, wherein:
the selecting comprises selecting a first set of products of the online store and a second set of products of the online store; and
the executing comprises executing the rules by the computer in a hierarchical manner, thereby selecting the first set of products before selecting the second set of products, based upon attributes of the first set of products matching more attributes of the personalized information about the actual visitor than attributes of the second set of products match attributes of the personalized information about the actual visitor.

3. The method of claim 2, wherein:
one rule of the rules is tree structured, the one rule consisting of rule portions organized as nodes, the nodes including child nodes; and
the executing comprises traversing the tree structure, executing a rule portion constituting a child of a node before executing a rule portion constituting the node.

4. The method of claim 1, wherein:
the storing comprises storing the rules in a folder of a collection, the collection containing a plurality of folders; and
the executing comprises querying other folders of the collection about products of the online product store based upon the personalized information about the actual visitor.

5. The method of claim 4, wherein at least one of the folders contains key/value pairs.

6. The method of claim 5, wherein:
the rules consist of key/value pairs; and
the method further comprises representing the keys by bit masks.

7. The method of claim 6, wherein the representing comprises hashing the keys by a dictionary-based hash algorithm.

8. The method of claim 7, wherein:
the method further comprises representing keys of the other folders of the collection by bit masks; and
the executing comprises comparing bit masks of keys of the rules with bit masks of keys of the other folders of the collection.

9. The method of claim 4, wherein:
a first folder of the other folders of the collection specifies a location of product information about a first set of products;
one rule of the rules provides for querying the first folder; and
the executing comprises executing the one rule of the rules, thereby displaying product information from the location specified in the first folder.

10. The method of claim 9, wherein:
the first folder includes the location of information about the first set of products, wherein each product of the first set of products matches a first set of attributes of the personalized information about the actual visitor;
a second folder includes a location of information about a second set of products, wherein each product of the second set of products matches a second set of attributes of the personalized information about the actual visitor, and wherein the second set of attributes is a subset of the first set of attributes; and
a rule of the rules provides for querying the first folder for product information before querying the second folder for product information.

11. The method of claim 10, wherein querying the second folder for product information comprises:
comparing a first key/value pair obtained from querying the first folder with a second key/value pair obtained from querying the second folder; and
discarding the second key/value pair based upon determining that the key of the first key/value pair equals the key of the second key/value pair and the value of the first key/value pair is not equal to the value of the second key/value pair.

12. The method of claim 9, wherein:
executing the one rule of the rules results in the generation of a query, the query specifying:
a search of the first folder via a first sub query of the query; and
a search via a second sub query of the query, wherein the search via the second sub query may be a search of the first folder or a search of another folder.

13. The method of claim 12, wherein the query is formulated in an extension of SQL.

14. The method of claim 4, wherein:
the storing comprises storing a set of default rules and another set of rules;
the other set of rules specifies a set of attributes; and
the executing comprises executing the other set of rules and not executing the set of default rules, based upon matching attributes of the personalized information about the actual visitor to the set of attributes specified by the other set of rules.

15. The method of claim 4, further comprising:
removing the folder of the collection storing the rules;
adding a folder to the collection storing other rules;
retaining the other folders of the collection; and
executing the other rules, comprising querying the other folders of the collection.

16. The method of claim 1, wherein the displaying product information comprises displaying product information from an external source via a predefined remote procedure call.

17. A system comprising:
a memory; and
a processor for executing instructions stored in the memory to perform a method comprising:
storing in a persistence layer a plurality of rules specifying an association between personalized information about potential visitors to an online product store and products of the online product store;
obtaining personalized information about an actual visitor to the online product store;
executing the rules by a computer, thereby selecting products of the online store based upon the personalized information about the actual visitor; and
displaying information about the selected products of the online store to the actual visitor.

18. A non-transitory computer-readable medium comprising:
instructions to store in a persistence layer a plurality of rules specifying an association between personalized information about potential visitors to an online product store and products of the online product store;
instructions to obtain personalized information about an actual visitor to the online product store;
instructions to execute the rules, thereby selecting products of the online store based upon the personalized information about the actual visitor; and
instructions to display information about the selected products of the online store to the actual visitor.

19. The non-transitory computer-readable medium or mediums of claim 18, wherein:
the instructions to select comprise instructions to select a first set of products of the online store and a second set of products of the online store; and
the instructions to execute comprise instructions to execute the rules in a hierarchical manner, thereby selecting the first set of products before selecting the second set of products, based upon attributes of the first set of products matching more attributes of the personalized information about the actual visitor than attributes of the second set of products match attributes of the personalized information about the actual visitor.

20. The non-transitory computer-readable medium or mediums of claim 18, wherein:
the instructions to storing comprise instructions to store the rules in a folder of a collection, the collection containing a plurality of folders; and
the instructions to execute comprise instructions to query other folders of the collection about products of the online product store based upon the personalized information about the actual visitor.
